(19) United States
(12) Patent Application Publication
(10) Pub. No.: US 2026/0077431 A1
(43) Pub. Date: Mar. 19, 2026

(54) METHOD FOR LASER WELDING

(71) Applicant: Robert Bosch GmbH, Stuttgart (DE)

(72) Inventors: Alexander Ilin, Ludwigsburg (DE); Adina Kerstin Dais, Calw (DE); Peter Stritt, Leonberg (DE)

(21) Appl. No.: 19/320,448

(22) Filed: Sep. 5, 2025

(30) Foreign Application Priority Data
Sep. 17, 2024 (DE) 10 2024 208 888.9

(51) Int. Cl. B23K 26/26

(52) U.S. Cl. CPC B23K 26/26

(57) ABSTRACT

A method for laser welding. A weld seam is produced by a laser from a start region to a target region on a target by targetedly applying laser light to the target from the start region to the target region. The laser light in the start region and/or in the target region of the weld seam is split into a main spot and at least one secondary spot for heating a surrounding area of the incidence region of the main spot on the target, and only one main spot is formed between the start region and the target region during the welding process, which main spot is guided along the weld seam on the target.

### BACKGROUND INFORMATION

Germany Patent Application DE 10 2011 004 116 A1 describes a method for welding components by means of a laser beam. Here, the laser beam is moved along a joining zone of the components, wherein the material of the components, which in particular consist of metal material, is melted in the region of the joining zone. Furthermore, a second, subordinate laser beam is provided, which heats a trailing region of the melt. This measure can improve the welding result.

PCT Patent Application No. WO 2011/151818 A1 describes a laser system in which an optical phased array and thus a laser beam pattern can be produced by means of coherent beam combining, i.e., with phase modulation of the individual beams.

### SUMMARY

A method for laser welding according to the present invention may have an advantage that a main spot and at least one secondary spot of a laser beam are produced only in a start region and in an end region of a weld seam.

It has been found that an experimental improvement in the welding result can be achieved by providing a main laser beam and one or more secondary laser beams, especially in a start region and in an end region of the weld seam. In the start region, this is caused by the fact that when the laser beam is activated at the beginning of the welding process, there is a strong temperature increase, so that a steep temperature gradient forms around the welding point. In the case of sudden heating at the beginning of the melting process, the local heating in particular can lead to metals evaporating at the beginning of the welding process and so-called welding spatter can form from liquid or solid metal particles that are ejected from the liquid metal of the melt pool. As a result, the quality of the weld seam can be reduced, and weld spatter may accumulate in the vicinity of the weld seam, so that, for example, electrical contacts can be undesirably established between current-conducting tracks. Due to the secondary laser beam, this temperature gradient is reduced, and by heating the surrounding area of the main spot when the weld pool is started, such weld spatter is effectively avoided.

In a similar manner, the sudden switching off of a laser beam when the welding process is terminated leads to a steep temperature gradient. If the weld pool cools down too quickly at the end of the weld seam, a so-called welding crater can form at the end of the weld seam. Such a welding crater can significantly reduce the quality of the weld seam. Due to uniform heating by secondary spots around the main spot, such a welding crater can be effectively avoided. This is because the secondary laser beam or the secondary laser beams cause the surrounding area of the main spot to heat up, so that a temperature gradient around the welding point itself is flatter than if the entire laser power were concentrated on one main spot.

The aforementioned impairments of the weld seam occur with a low probability outside the start and target region, so that in this region it is possible to concentrate on the main spot of the laser that carries out the welding process. During the ongoing welding process, the heat flow from the welding point into the surrounding area of the welding point is already sufficient to provide sufficient heat input into the immediate surrounding area of the welding point and to keep a temperature gradient limited, so that it is advantageous to concentrate the entire available laser power on the welding point itself.

It is therefore advantageous that, after a start region of the weld seam, the secondary spot is fused with the main spot, and that only before an end region of the weld seam one or more secondary spots are formed again. In this way, the advantages of splitting a laser beam into a main spot and at least one secondary spot can be utilized in the start and end regions, while otherwise the full laser power is available for carrying out the welding process, so that the welding process can be carried out in the shortest possible time. This allows defects to be avoided, in particular at the ends of the weld seam, while the welding process can be reliably carried out quickly and with high quality.

Further advantages of the present invention are disclosed herein. It is advantageous that the main spot and the at least one secondary spot from a laser beam device are formed by means of a controllable optical unit for coherent beam combining. As a result, simple shaping of the main spot and the secondary spot or spots is possible. In particular, it is possible to form the spots dynamically in such a way that the secondary spots are brought toward the main spot and combined with it and are guided out of the main spot again in a region at the end of the weld seam. Installing additional laser modules is then not necessary to form the secondary spots.

For a good formation of the weld seam, it has been found that a number of between four and 20 secondary spots, in particular between four and eight secondary spots, provides advantages with respect to uniform heat distribution.

Furthermore, according to an example embodiment of the present invention, it is advantageous to configure a length of a start or target region so that this length is at most five times the width of the weld seam. As a result, the use of secondary spots can be limited to a region in which this splitting offers advantages.

Furthermore, according to an example embodiment of the present invention, it is advantageous that the main spot has a diameter of 50 μm to 150 μm, since selecting this width can result in the formation of a reliable weld seam between metal parts.

For a start region of the welding process, it has been found that a distance of between 100 μm and 400 μm between the main spot and the secondary spot is advantageous. In order to make dynamic guidance of the secondary spot to the main spot possible, the movement speed of the secondary spots can be configured independently of that of the main spot.

For certain applications, according to an example embodiment of the present invention, it may also be advantageous for main and secondary spots to be directly adjacent to one another, overlap at the edges or form a defined pattern. This ensures a specified quality of the welded joint. The main spot preferably has at least twice, in particular five times, the radiation power of the at least one secondary spot, so that the melting band reaches its greatest depth in a central region of the main spot.

Furthermore, according to an example embodiment of the present invention, it is advantageous that the diameter of the at least one secondary spot on the target changes with time or with a movement of the main spot in order to achieve an adjustment to a desired configuration of the weld seam.

Furthermore, a device according to the present invention for carrying out the method of the present invention, in which a control unit is provided that localizes the start and/or target region of the weld seam, is advantageous.

Corresponding advantages also arise for a computer program product comprising instructions which, when the program is executed by a computer, cause a device to carry out the method according to the present invention.

### BRIEF DESCRIPTION OF THE DRAWINGS

Exemplary embodiments of the present invention are illustrated in the figures and explained in more detail in the following description.

FIG. 1 shows a device according to an example embodiment of the present invention for carrying out the method.

FIG. 2A shows a first exemplary embodiment for a splitting of main and secondary spots along the weld seam, according to the present invention.

FIG. 2B shows a detail of the splitting between main and secondary spots according to FIG. 2A.

FIG. 3 to 6 show various exemplary embodiments for a configuration of the main and secondary spots in the start region and target region of the weld seam, according to an example embodiment of the present invention.

### DETAILED DESCRIPTION OF EXAMPLE EMBODIMENTS

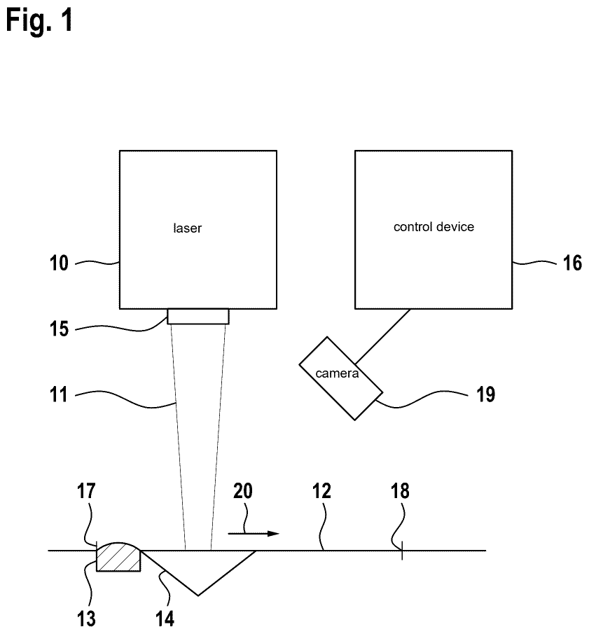

FIG. 1 shows a laser 10 of a laser welding device, wherein the laser 10 directs a laser beam 11 onto a target 12. The target 12 consists, for example, of metal elements arranged next to one another, which are to be connected by a weld seam 13 indicated by dashed lines. For this purpose, the laser beam 11 produces a melt pool 14 in the material of the target 12, which, upon cooling, results in the formation of the weld seam 13 and connects metal individual elements of the target to one another. Via a preferably controllable optical system 15, the laser beam 11 is targetedly directed onto the target 12. The laser beam 11 is controlled by a control device 16, which guides the laser beam 11 from a start point 17 of the weld seam 13 to an end point 18 of the weld seam 13. In one embodiment, the welding process can be observed via a camera 19, so that control by the control device 16 can be carried out according to the welding process detected by the camera 19. The laser beam is guided in the arrow direction 20 from the start point 17 to the end point 18.

The control device 16 is designed such that, in particular in a start region in the vicinity of the start point 17 and in an end region in the vicinity of the end point 18 of the weld seam, a variable energy distribution of the laser beam is carried out between a main spot and at least one, optionally a plurality of, secondary spots. As a result, disruptive welding effects at the beginning and at the end of the weld seam 13 are suppressed. By applying beam shaping which deviates from a central spot only at the beginning and end of the welding process, the remainder of the weld seam is not affected by the variable energy distribution. Outside the initial and end regions, the laser power is focused into a main beam. It is thus possible to adjust the beam shaping in the initial and end regions of the weld seam 13 to different process requirements and to different materials used, without requiring a modification of the installation.

In one embodiment, a plurality of laser light sources, in each case with an associated deflectable optical unit, can be focused either into a main spot or into a main spot and one or more secondary spots. In another embodiment, this can also be implemented with only a single laser light source, in which either only the main spot is produced from the produced laser beam, or in which, in addition to the main spot, one or more secondary spots are coupled out of the produced laser light.

In an advantageous configuration, beam shaping with a dynamic and highly flexible energy distribution is carried out with the aid of a fiber laser that comprises individual phases that are superimposed via coherent beam combining. By means of phase modulation of the individual beams, an optical phase array is formed, so that on the one hand the beam movement, but on the other hand also beam shaping, focus formation and intensity modulation of the laser beam is possible. In particular, it is possible to form a main spot and one or more secondary spots.

Here, a rapid adjustment of the beam in the megahertz range is possible.

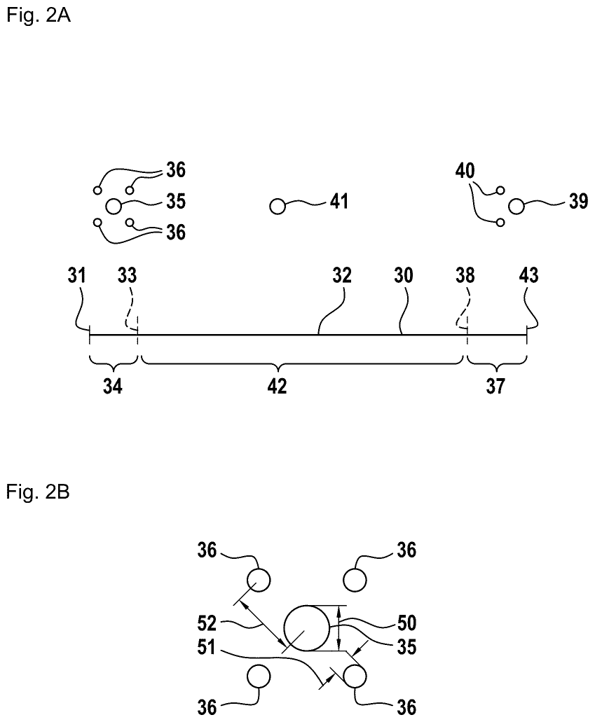

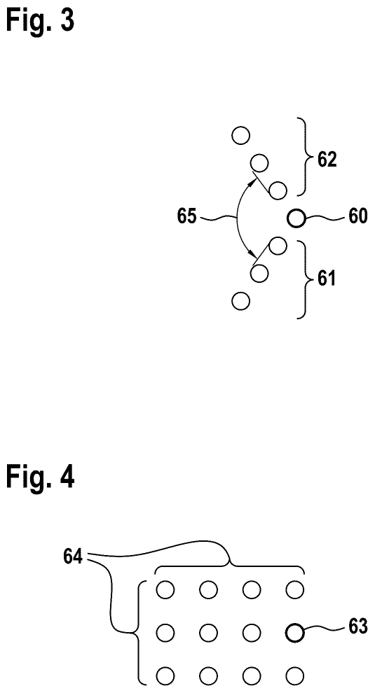

FIG. 2A shows an exemplary embodiment of a weld seam 30 that is guided from a start point 31 to an end point 43. A start region 34 is delimited from the start point 31 by a dashed line 33, which is preferably multiple times, at least twice, in particular at least five times, and possibly even ten times, the width of the weld seam 30. Adjacent to the weld seam 32, FIG. 2A symbolically shows a pattern for the laser beam in which a main spot 35 is surrounded by a plurality of secondary spots 36.

In a corresponding manner, a target region 37 of the weld seam 32 is shown delimited by a dashed line 38 relative to the end point 43, symbolically representing an alternative pattern for a splitting between a main spot 39 and a secondary spot 40. Along the weld seam 30 between the dashed lines 33 and 38, a normal region for the weld seam 30 is shown, within which welding is carried out with only one main spot 41.

In a first embodiment, switching can take place directly between the illustrated patterns of the laser distribution at the boundary between the start region 34 and the normal region 42, along with between the normal region 42 and the target region 37. However, in an alternative embodiment, it is also possible that the secondary spots in the start region 34 approach the main spot 35 as the distance from the start point 31 increases, so that the single main spot 41 is formed as a result of the approach during the transition to the normal region. In a corresponding manner, the secondary spots can be dynamically decoupled from the main spot 35 at the transition 38 to the end region 37.

In FIG. 2B, the main and secondary spots of FIG. 2A are shown in detail. The corresponding splitting according to FIG. 2B is preferably designed to avoid welding spatter at the beginning of the welding process. Due to the heating of the surrounding area by the secondary spots 36, the temperature gradient from the main spot 35 to its surrounding area is reduced, so that the formation of welding spatter is avoided. The configuration of the parameters such as size and power for the main and secondary spots 35, 36 depends on the configuration of the weld seam, the material or materials to be welded, e.g. if different materials are used, the material design, e.g. the surface quality, and other parameters of the surrounding area. In particular, the following can be changed: the number of secondary spots 36, a focus diameter 50 of the main spot 35, a focus diameter 51 of the secondary spots 36, a distance 52 between the main spot 35 and the secondary spot 36, the radiation power of the main spot 35 and the radiation power of the secondary spots 36. The speed at which the main and secondary spots 35, 36 move over the target 12 can also be adjusted.

A number of secondary spots between 4 and 20, in particular 4 to 8, a focus diameter 50 of the main spot of 50 to 150 μm, in particular of 75 to 100 μm, a focus diameter 51 of the secondary spots of 50 to 150 μm, in particular of 50 to 100 μm, a distance between the main spot 35 and the secondary spot 36 of 100 to 300 μm, in particular of 100 to 200 μm, a power of the main spot of 100 watts to 12 kilowatts, in particular of 500 kilowatts to 10 kilowatts and a power of the secondary spots of 100 watts to 6 kilowatts, in particular of 500 watts to 5 kilowatts, has proven advantageous. The advance speed of the main and secondary spots is preferably between one and 200 mm per second, in particular between 5 and 100 mm per second.

The proposed distance between the main and secondary spots can decrease from the start point 31 to a transition 33 into the normal region 42, so that when moving along the weld seam 32 to be generated, the movement speed of the main and secondary spots are different in order to make an approach of the secondary spots to the main spot possible.

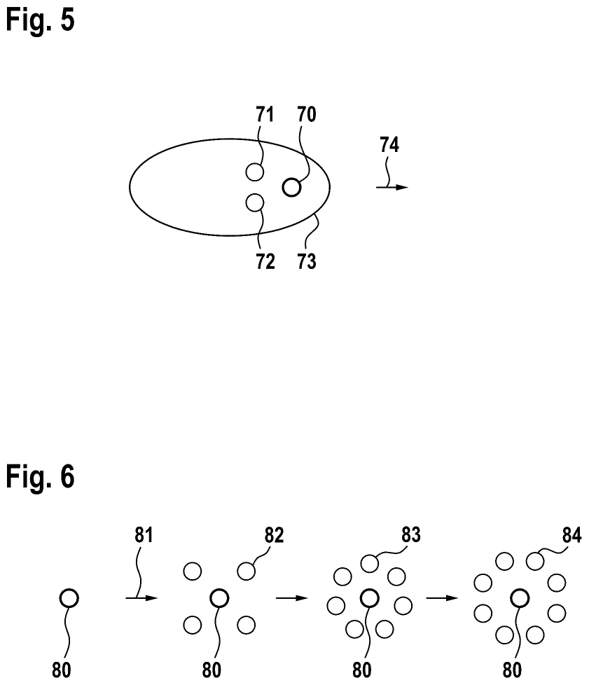

FIG. 3 shows an alternative pattern in which, starting from a main spot 60, secondary spots 61, 62 are provided in two directions, so that the secondary spots 61, 62 form an angle 65, at the apex of which the main spot 60 is arranged.

In a further embodiment according to FIG. 4, a regular grid of secondary spots 64 can also be formed, between which a main spot 63 is optionally provided on a front side of the grid field in the direction of welding progress.

For an end region of the welding process, as shown in FIG. 5, a so-called trailing beam is provided in a first embodiment, in which a main spot 70 leads, which is followed by two or more secondary spots 71, 72, here two secondary spots. In the surrounding area of the main spot 70 and the secondary spot 71, 72, the melt pool 73 is shown, wherein the main spot moves in the arrow direction 74 to one end of the weld seam. In another embodiment, it may also be possible to swap the position of main and secondary spots with respect to the welding direction. This means that the weld seam depth can be increased in stages using the partial beams.

If the secondary spots at the end of the weld seam follow the main spot, as shown in FIG. 5, it is possible to redirect or slow down the flows in the melt pool, so that a main influencing factor for the formation of a weld end crater is minimized. Here as well, the distance to the main spot and the power of the secondary spots may need to be adjusted experimentally.

An alternative embodiment, in particular for a procedure at one end of the weld seam, is shown in FIG. 6, wherein a development of a main spot 80 from a beginning of the end region to an end of the weld seam and a switching off of the laser is shown in the arrow direction 81. In this embodiment, initially four secondary spots 82 are formed, then seven secondary spots 83 and then eight secondary spots 84, which move away from the main spot 80 as they approach the end of the weld seam and which gain more and more power in relation to the main spot. Alternatively, four, then six and then nine secondary spots are also possible. Thus, during the formation of the secondary spots 84, the surrounding area of the main spot is heated uniformly, so that a thermal gradient is reduced and, when the main spot is switched off, the formation of a welding end crater is avoided. Preferably, 4 to 20 secondary spots, in particular 4 to 8 secondary spots are provided. The end distance to the main spot is 100 to 400 μm, in particular 100 to 300 μm.

1-12. (canceled)

13. A method for laser welding, the method comprising the following steps:
producing a weld seam by a laser from a start region to a target region on a target by targetedly applying laser light to the target from the start region to the target region;
wherein the laser light in the start region and/or in the target region of the weld seam is split into a main spot and at least one secondary spot for heating a surrounding area of the incidence region of the main spot on the target, and only one main spot is formed between the start region and the target region during the welding process, which the main spot being guided along the weld seam on the target.

14. The method according to claim 13, wherein the main spot and the at least one secondary spot are formed by a laser using a controllable optical unit for coherent beam combining.

15. The method according to claim 13, wherein between four and twenty secondary spots are formed.

16. The method according to claim 13, wherein a length of the start and/or target region is at most five times a width of the weld seam.

17. The method according to claim 13, wherein the main spot has a diameter of 50 to 150 μm, and each of the at least one secondary spots has a diameter of 25 μm to 150 μm.

18. The method according to claim 13, wherein the at least one secondary spot has a plurality of secondary spots, which are each arranged at a specified distance from a center of the main spot at a distance between 100 and 450 μm.

19. The method according to claim 18, wherein the distance of the secondary spots from the center of the main spot and/or a movement speed of the secondary spots changes with time or with a movement of the main spot.

20. The method according to claim 13, wherein the main and the at least one secondary spot are directly adjacent to one another or overlap at the edges in such a way that a defined pattern consisting of main and the at least one secondary spot is formed.

21. The method according to claim 13, wherein the main spot has at least twice a radiation power of the at least one secondary spot.

22. The method according to claim 13, wherein a diameter of the at least one secondary spot on the target changes with time or with a movement of the main spot.

23. A device for laser welding, comprising:
a laser for coherent beam combining; and
a control unit for localizing a start and/or target region of a weld seam;
wherein the device is configured to:
produce the weld seam by the laser from the start region to the target region on a target by targetedly applying laser light to the target from the start region to the target region,
wherein the laser light in the start region and/or in the target region of the weld seam is split into a main spot and at least one secondary spot for heating a surrounding area of the incidence region of the main spot on the target, and only one main spot is formed between the start region and the target region during the welding process, which the main spot being guided along the weld seam on the target.

24. A non-transitory computer-readable medium on which is stored a computer program including instructions for laser welding, the instructions, when executed by a computer, causing the computer to perform the following steps:
producing a weld seam by a laser from a start region to a target region on a target by targetedly applying laser light to the target from the start region to the target region;
wherein the laser light in the start region and/or in the target region of the weld seam is split into a main spot and at least one secondary spot for heating a surrounding area of the incidence region of the main spot on the target, and only one main spot is formed between the start region and the target region during the welding process, which the main spot being guided along the weld seam on the target.
